(19) United States
(12) Patent Application Publication
(10) Pub. No.: US 2005/0204125 A1
(43) Pub. Date: Sep. 15, 2005

(54) Method for automatically changing the hardware settings of a computer in accordance with an executing application program

(76) Inventor: Cheng-Hao Chin, Taipei County (TW)

Correspondence Address: BIRCH STEWART KOLASCH & BIRCH, PO BOX 747, FALLS CHURCH, VA, 22040-0747, US

(21) Appl. No.: 10/834,876

(22) Filed: Apr. 30, 2004

(30) Foreign Application Priority Data
Mar. 12, 2004 (TW) 093106578

(51) Int. Cl. G06F 1/24

(52) U.S. Cl. 713/100

(57) ABSTRACT

The present invention provides a method for changing the hardware settings on a computer automatically in accordance with an executed application program. The method dynamically changes the setting, e.g. voltage, frequency, rotational speed of a fan, sound volume, sound effect, etc. of the hardware of the computer in accordance with the current executed application program of the computer automatically to meet the hardware requirements of the of the user in accordance with a specific application program. According to the method, the setting of the hardware corresponding to the application program is stored in a configuration file of the hardware, and the initialization and termination of all application programs are monitored by utilizing a terminate-and-stay-resident program of the computer. A user the terminate-and-stay-resident program can automatically revise the current settings of the hardware of the computer to a user default of the hardware, which is defined by the user if the application program which is defined in advance is executed, and return to the initial default of the computer if the program is finished.

### FIELD OF THE INVENTION

The present invention relates to a method for changing the hardware settings of a computer, and more particularly to a method for dynamically changing the hardware settings of a computer to a customized preset automatically in accordance with a currently executing application program, wherein the custom settings of the hardware is set by a user in advance according to a specific application program.

### BACKGROUND OF THE INVENTION

Typically, in order to acquire the highest performance of a personal computer, a computer expert utilizes the settings of the basic input/output system (BIOS) to adjust the working frequency, voltage, etc. of a central processing unit (CPU) of the computer to obtain the best performance of the computer. Also, some built-in software is used in the operation system (OS) of the computer to adjust the same items: the working frequency, voltage, etc., but there are the following problems with the prior art.

(1). The computer is kept to the working frequency with the highest performance after the computer is adjusted. If a user does not consider whether current software and application program need the working frequency with high performance, and therefore an inefficient use of energy.

(2). Setting the working frequency or voltage higher than that of the original design generates extra heat energy, and therefore a user generally uses a fan with high rotational speed for further spreading the heat energy. However, fans with a high rotational speed generate much more noise.

(3). If the working frequency or voltage is used higher than that of the original design for a long time, then the lifetime of the computer will easily decrease.

(4). Generally, the user defaults which are preset in the BIOS do not include special effects or functions controlled by software, e.g. the displaying mode of sound field or sound effects, such that the user defaults are restricted.

### SUMMARY OF THE INVENTION

It is an object of the present invention to provide a method for dynamically changing the hardware settings of a computer automatically in accordance with an executing application program.

The method of the present invention provides a terminate-and-stay-resident program that is executed in accordance with the logic of settings and a configuration file of hardware for realizing the method. A user utilizes the terminate-and-stay-resident program for storing an expected setting of the hardware of a selected application program into the configuration file of the hardware in advance. The configuration file of the hardware stores the initial default of the hardware of the computer, information of the application program, and at least one user default e.g. voltage, frequency, rotational speed of a fan, sound volume, sound effect, etc. corresponding to the application program. Starting and finishing of all application programs are monitored by a utilizing mode of the terminate-and-stay-resident program of the computer. The terminate-and-stay-resident program can automatically revise a current setting of the hardware of the computer to a user default of the hardware of the application program corresponding to the configuration file of the hardware if the application program, which is defined in advance, is started, and return to the initial default of the computer if the application program is finished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flow diagram showing a method of the present invention.

FIG. 2 is a block diagram showing operating processes of the whole method in a computer according to a preferred embodiment of the method of the present invention.

FIG. 3 is a functional block diagram showing a hardware structure according to a method of the present invention.

FIG. 4 is a flow diagram showing a preferred embodiment of the method of the present invention.

### DESCRIPTION OF THE PREFERRED EMBODIMENTS

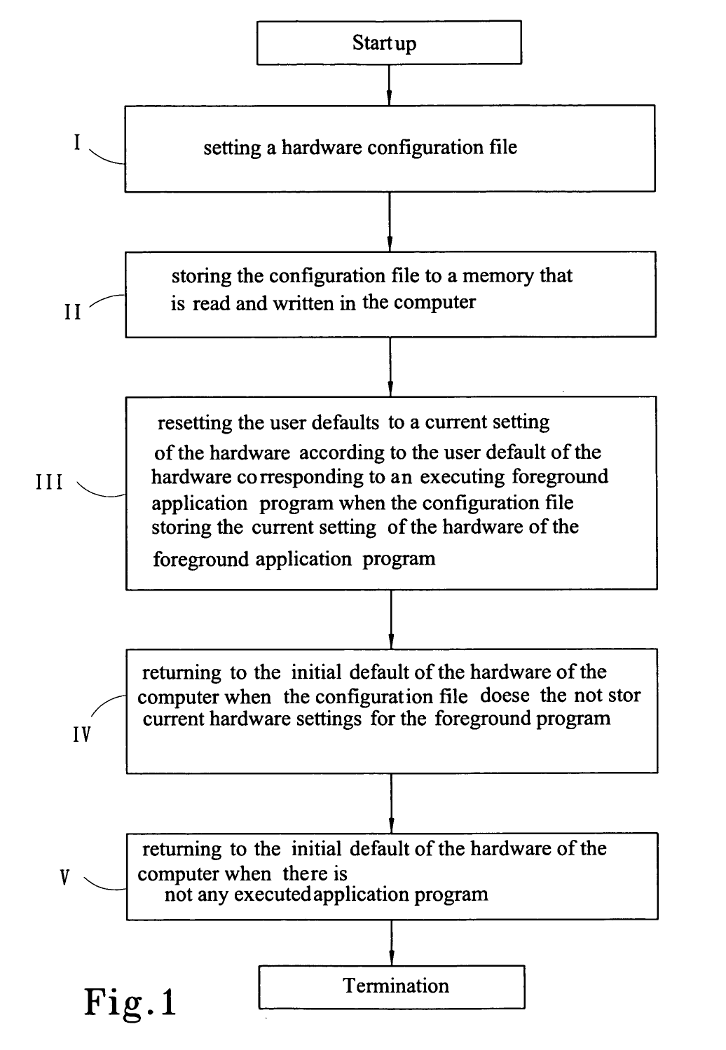

Referring FIG. 1, it depicts a method disclosed by the present invention. The method includes the following steps of:
I. setting up a configuration file of a hardware, wherein the configuration file stores a plurality of initial defaults of the hardware of a computer, information of an application program, and at least one user default (e.g. voltage, frequency, rotational speed of a fan, sound volume, sound effect and the like) of the hardware corresponding to the application program;
II. storing the configuration file in the computers memory memory, which can be read from and written to;
III. resetting the user default to a current setting of the hardware according to the user default of the hardware corresponding to an executing foreground program when the configuration file storing the current hardware settings of the foreground program;
IV. returning to the initial hardware defaults of the computer when the configuration file is not storing the current settings of the hardware of the foreground program; and
V. returning the initial defaults of the computer when the finished application program is defined in advance. (I.e. the finished application program has been stored in the configuration file of the hardware.)

The steps of the above-mentioned method are executed by means of the computers internal read/write memory. According to a preferred embodiment of the present invention, the steps of the above-mentioned method are executed in an operation system of the computer by means of a mode of a terminate-and-stay-resident program. The configuration file of the hardware is also stored in memory which can be read from and written to in the computer, and accessed in the same way by the terminate-and-stay-resident program or operated on by means of revised, added, deleted editing, etc. Simultaneously, the memory that can be read and written in the computer includes a compact disc (CD), a hard disk, a memory/buffer, or the like.

According to the preferred embodiment of the present invention, the configuration file of the hardware has stored the initial hardware default settings of the computer, at least one fact about the application program, and at least one user default of the hardware corresponding to the application program. Typically, the configuration file of the hardware has stored a plurality of information of the application programs and the user defaults of the hardware respectively corresponding to the application program.

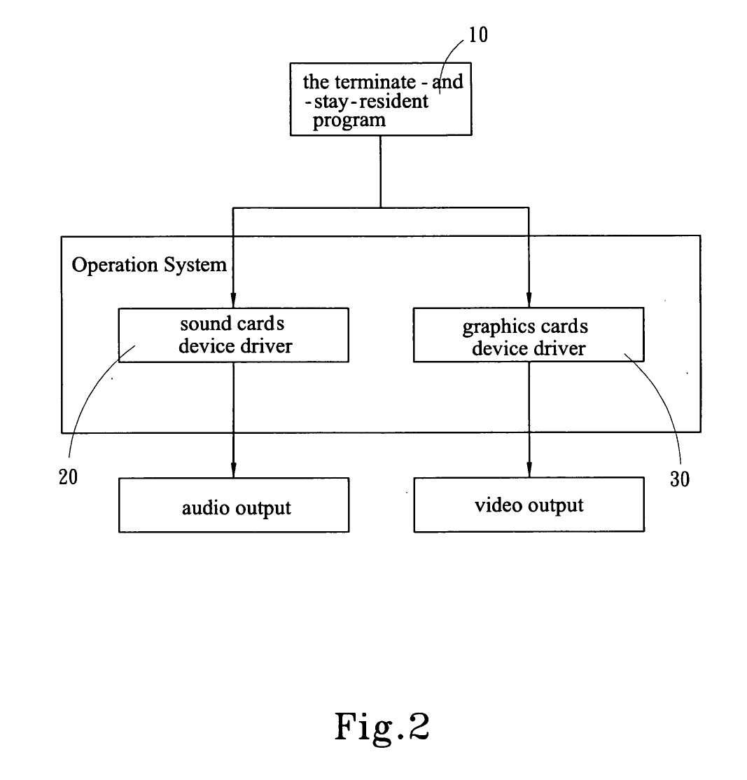

The above-mentioned user settings of the hardware depends on the necessary hardware-performance or output effect of the user in advance, called “Hardware profiles”, and the above-mentioned user settings are different from “the initial defaults of the hardware of the computer” described above. Typically, the initial defaults have been set up by a hardware manufacturer before the hardware is sold. The initial defaults are generally stored in the hardware device drivers or a configuration file of the hardware initial defaults. As shown in FIG. 2, “the terminate-and-stay-resident program” 10 of the present invention achieves the expected output for sound effects by changing the settings of “sound card's device driver” 20 or the expected video display by changing the settings of “graphics card's device driver” 30.

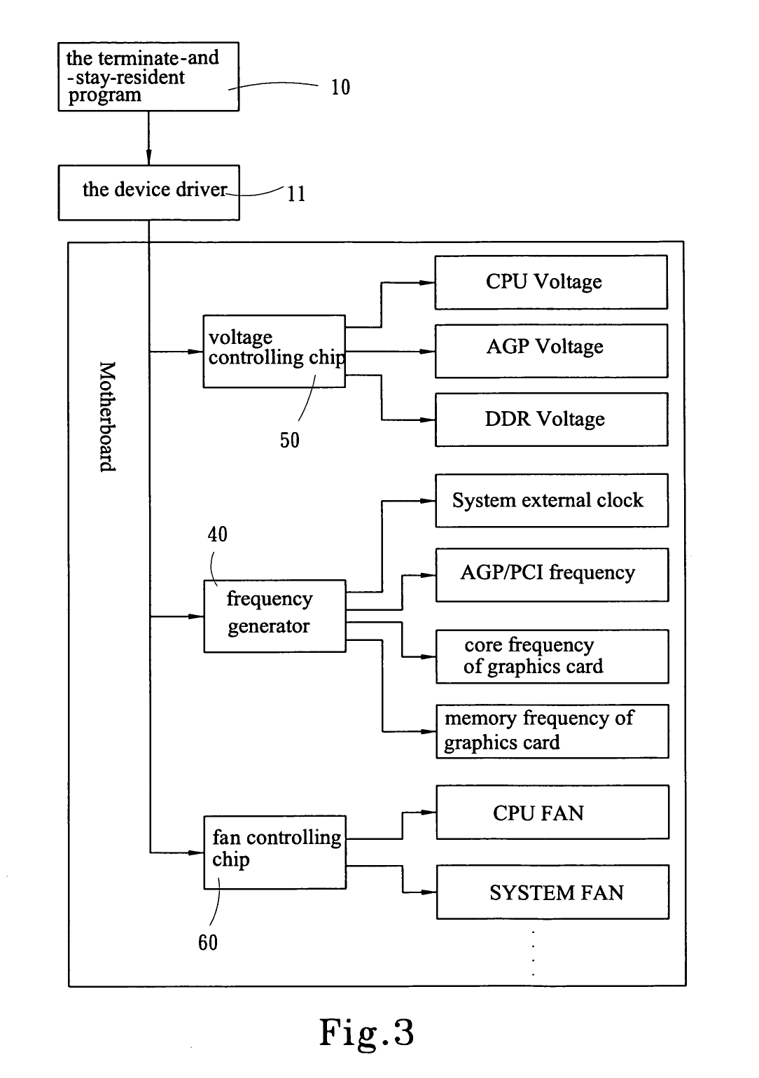

The present invention provides a method to dynamically change the various hardware settings according to each application program from “the terminate-and-stay-resident program” 10 automatically through “the device driver” 11, and a partial structure thereof is simply shown in FIG. 3. There are examples as follows:
change of frequency: e.g. the method utilizes “a frequency generator” 40 corresponding to “the device driver” 11 to change the system external clock, the frequency of an accelerated graphics port (AGP)/a protocol control information (PCI), the core frequency of the graphics card and the frequency of the graphics cards memory;
change of voltage: e.g. the method utilizes “a voltage controlling chip” 50 corresponding to “the device driver” 11 to change the core voltage of CPU, the voltage of a double data rate (DDR) memory and the voltage of the accelerated graphics port (AGP);
a change in the fans rotational speed: e.g. the method utilizes “a fan controlling chip” 60 corresponding to “the device driver” 11 to change the rotational speed of a CPU fan, a system fan, etc.;
change of sound effect (the device driver of the sound effect is requested to match): e.g. the sound volume, the sound field and the setting of multi-channel (2/4/5.1/7.1 channels); and
change of a screen (the video driver for the graphics card is requested to match): e.g. the brightness, the contrast and the Gamma value.

The default frequency, voltage and rotational speed of the fan are based on the initial defaults (the BIOS settings) during startup of the computer, and the default of the sound effect and screen are based on the settings when starting the program.

The correlative settings of every application program are based on the setting by a user, every application program corresponds to at least one set of parameters, and the application program corresponds to the set of parameters entered into the system after the application program has started or has converts to work in the foreground.

In order to automatically cause the hardware performance or output effect to meet the users requirements when the hardware of the computer is utilized by different application programs, the user is permitted to decide if the user default of the hardware corresponding to the selected application program according to the method disclosed in the preferred embodiment of the present invention by providing an operating interface (an operating window under a window-based operation system). For example, when some application program is a three-dimensional (3D) computer game, the application program needs to perform fast and complex mathematical operations. In other words, the application program needs higher performance from the 3D video card. The user can set the information of the application program (i.e., 3D computer game) and at least one user default of the hardware, such as the working frequency or the rotational speed of the fan (a heat spreading fan of CPU) corresponding to the application program via the above-mentioned operating interface, and then the user default of the hardware is stored in the configuration file of the hardware. Furthermore, for example, when the user is watching a movie or listening to music through the computer, high hardware performance is not required. Thus, the user can define in advance so that the hardware settings can automatically switch from high requirements to low requirements on the hardware and decrease the rotational speed of the fan to keep quiet for the computer.

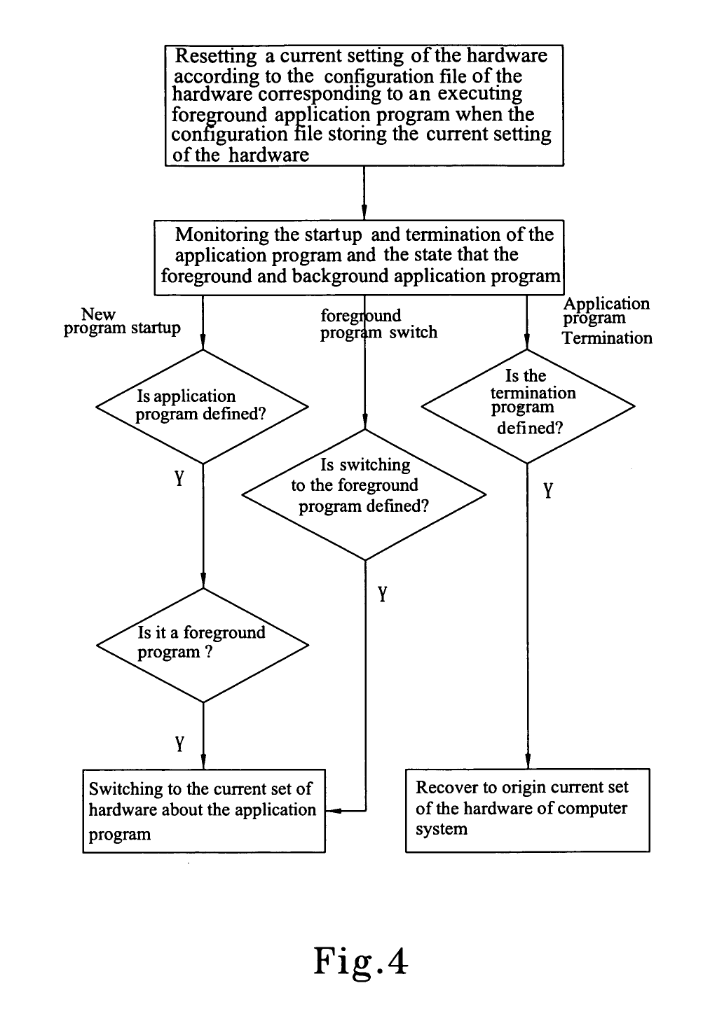

Referring to FIG. 4, depicts a preferred embodiment of the method of the present invention and describes operating processes of the whole method in the computer. The method includes the following steps of:
(A). revising the correlative setting of the hardware according to the specific application program and storing the revised hardware settings in a hardware configuration file;
(B). monitoring the startup and termination of the application program and the state that the foreground and background application program are switched to each other by utilizing the terminate-and-stay-resident program of the computer;
(C). resetting a user default of the hardware to a current setting of the hardware of the computer when a started program is defined in advance (i.e., the configuration file of the hardware stores the user default of the hardware corresponding to the program) and the current foreground application program of the operation system, wherein the user default of the hardware is stored in the configuration file of the hardware and corresponds to the foreground application program;
(D). setting a user profile of the hardware to a current setting of the hardware of the computer when a program is replaced and in advance defined and the current foreground application program of the operation system, wherein the user presets of the hardware is stored in a configuration file of the hardware and corresponding to the foreground application program; and
(E). returning to the initial default of the hard of the computer when a terminated application program is defined in advance.

The method of the present invention dynamically changes the settings of the computer hardware in accordance with the current executed application program of the computer automatically to meet user requirements in accordance with a specific application program.

The initial default is returned after the application program is finished, and therefore it is helpful for the lifetime of hardware of the computer.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A method for automatically changing the hardware settings of a computer in accordance with an executing application program comprising the following steps of:
I. setting up a hardware configuration file, wherein the configuration file stores a plurality of initial hardware defaults of a computer, information of an application program, and at least one user default for the hardware corresponding to the application program;
II. storing the configuration file to a memory that is read and written in the computer;
III. resetting the user defaults to a current setting of the hardware according to the user default of the hardware corresponding to an executing foreground application program when the configuration file storing the current setting of the hardware of the foreground application program;
IV. returning to the initial default of the hardware of the computer when the configuration file does not store the current hardware settings for the foreground program; and
V. returning the initial defaults of the hardware of the computer when there is not any executed application program.

2. The method according to claim 1, wherein the hardware settings of the hardware is selected from at least one setting of group consisting of voltage, frequency, rotational speed of a fan, sound volume and sound effect.

3. The method according to claim 1, wherein the memory is a compact disc (CD).

4. The method according to claim 1, wherein the memory is a hard disk.

5. The method according to claim 1, wherein the memory is a memory/buffer.

6. The method according to claim 1, further comprising the following steps:
providing an operating interface to decide the user defaults of the hardware corresponding to the selected application program.

7. The method according to claim 1, further comprising the following steps:
providing a terminate-and-stay-resident program for executing the steps of the method.

8. The method according to claim 1, wherein the step III comprises the following step of:
judging whether a program is defined in advance and is a foreground application program.

9. The method according to claim 1, wherein the step III comprises the following steps:
Judging whether the foreground application program is defined in advance when the foreground application program is changed.

10. The method according to claim 1, wherein the step V comprises the following step of:
returning to the initial hardware defaults of the computer when an terminated application program is defined in advance.

11. Memory which is read and written to in a computer, and ordering the computer to the hardware setting of a hardware of the computer automatically in accordance with an executed application program by executing the following steps:
I. setting up a configuration file of a hardware, wherein the configuration file stores a plurality of initial defaults of the computer's hardware including: information of an application program, and at least one user default of the hardware corresponding to the application program;
II. storing the configuration file to memory, which is read and write in the computer;
III. resetting the user default to a current setting of the hardware according to the user default of the hardware corresponding to an executed foreground application program when the configuration file storing the current setting of the hardware of the foreground application program;
IV. returning to the initial default of the hardware of the computer when the configuration file does not store the current hardware settings of the hardware of the foreground program; and
V. returning to the initial default of the hardware of the computer when there is not any executed application program.

12. The memory which is read and written in a computer according to claim 11, wherein the setting of the hardware is selected from at least one setting of group consisting of voltage, frequency, rotational speed of a fan, sound volume and sound effect.

13. The memory which is read and written in a computer according to claim 11, wherein the memory is a compact disc (CD).

14. The memory which is read and written in a computer according to claim 11, wherein the memory is a hard disk.

15. The memory which is read and written in a computer according to claim 11, further comprising the following step of:
providing an operating interface to decide the user default of the hardware corresponding to the selected application program.

16. The memory which is read and written in a computer according to claim 11, further comprising the following step of:
providing a terminate-and-stay-resident program for executing the steps of the method.

17. The memory which is read and written in a computer according to claim 11, wherein the step III comprises the following step of:
judging whether a started program is defined in advance and is the foreground application program.

18. The memory which is read and written in a computer according to claim 11, wherein the step III comprises the following step of:
Judging whether the foreground application program is defined in advance when the foreground application program is changed.

19. The memory which is read and written in a computer according to claim 11, wherein the step V comprises the following step of:
returning to the initial hardware defaults of the computer when a terminated application program is defined in advance.
